(19) United States
(12) Patent Application Publication
(10) Pub. No.: US 2026/0127372 A1
(43) Pub. Date: May 7, 2026

(54) SYSTEM AND METHOD OF BUILDING A CUSTOMIZED SCENARIO FOR A VEHICLE WITH A LARGE LANGUAGE MODEL BASED ON A SERVICE-ORIENTED ARCHITECTURE

(71) Applicants: HYUNDAI MOTOR COMPANY, Seoul (KR); KIA CORPORATION, Seoul (KR)

(72) Inventors: Dong Niu, Yantai (CN); Feng Yang, Yantai (CN); Ruzhang Huang, Yantai (CN)

(73) Assignees: HYUNDAI MOTOR COMPANY, Seoul (KR); KIA CORPORATION, Seoul (KR)

(21) Appl. No.: 19/372,586

(22) Filed: Oct. 29, 2025

(30) Foreign Application Priority Data
Nov. 1, 2024 (CN) 202411554080.5

(51) Int. Cl. G06F 40/289; B60R 16/037; G06V 20/59; G06V 40/16

(52) U.S. Cl. CPC G06F 40/289; G06V 20/59; G06V 40/172; B60R 16/0373

(57) ABSTRACT

A system and a method may include a speech recognition device configured to acquire user speech information, convert the acquired user speech information into user demand information in a text form, classify the converted user demand information, determine whether a type of the user demand information is a customized scenario, and, if the type of the user demand information is determined to be the customized scenario, generate user demand information of the customized scenario. The system may further include a service-oriented architecture (SOA) atomic function library configured to provide status information of a sensor and an actuator of the vehicle. The system may further include a control device configured to analyze the user demand information based on large language models (LLMs) and generate a plan for a customized scenario suitable for a user demand by using user demand information of the customized scenario and the SOA atomic function library.

### CROSS-REFERENCE TO RELATED APPLICATION

This application claims priority to and the benefit of Chinese Patent Application No. 202411554080.5 filed on Nov. 1, 2024, the entire contents of which are incorporated herein by reference.

### BACKGROUND

### (a) Technical Field

The present disclosure relates to a smart vehicle and software architecture, and more particularly, to a system and method for building a customized scenario for a vehicle using large language models (LLMs) based on a service-oriented architecture (SOA).

### (b) Description of the Related Art

The content described in this section merely provides background information related to the present disclosure and does not constitute prior art.

Currently, vehicle manufacturers are developing smart scenario applications that run on a service-oriented architecture (SOA), and that allow a user to define various functions using sensors and actuators of the vehicle.

SOA is a design architecture that composes, i.e., structures or organizes, an application into a variety of independent services that are updatable and extendable independently without affecting the entire system. In this situation, various functions or processes (e.g., driving assistance, entertainment systems, navigation, and the like) of the vehicle may be implemented as independent “atomic” services, i.e., self-contained, reusable components, or specifically configured instances of containerized processes, i.e., containers, which may be combined and customized based on defined parameters such as user demands, i.e., requests, requirements, demands, and the like of users.

However, this customization process may lead to some problems. Users must have a certain level of technical knowledge to understand and operate this complex system. Further, manual editing and customization are difficult and time-consuming.

### SUMMARY

The present disclosure provides a system, e.g., a computing system, and method for understanding a user demand using large language models (LLMs) and generating corresponding output based on defined parameters such as data indicative of user demands or requests to control a vehicle. In particular, the disclosed embodiments provide a system and method that control the vehicle to execute different functions, e.g., causing a change on the driving mode of the vehicle, adjusting a seat temperature, changing a music playlist, and the like, in response to receiving simple language commands indicative of requests or demands received from a user. The disclosed embodiments may not only improve user experience, but also enhance safety and efficiency of the vehicle.

The disclosed systems and methods accurately understand user demand and eliminate difficulty when setting up customized scenarios by a user.

According to an embodiment of the present disclosure, a system is specifically configured to build a customized scenario for a vehicle using large language models (LLMs) based on a service-oriented architecture (SOA). The system may include a speech recognition device configured to acquire user speech information, convert the acquired user speech information into user demand information in a text form, classify the converted user demand information, determine whether a type of the user demand information is a customized scenario, and, based on determining that the type of the user demand information is the customized scenario, generate user demand information of the customized scenario. The system may further include an SOA atomic function library configured to provide status information of a sensor and an actuator of the vehicle. The system may further include a control device configured to be communicatively connected to the speech recognition device and the SOA atomic function library. The control device may be further configured to analyze the user demand information based on the LLMs and generate a plan for the customized scenario suitable for the user demand information by using user demand information of the customized scenario and the SOA atomic function library.

The system may further include a display device communicatively connected to the control device and configured to display the plan for the generated customized scenario to a user.

The system may further include a face recognition device configured to be communicatively connected to the control device, recognize facial information of a user, determine whether the user is a registered user, and transmit identity information of the determined user to the control device. The system may further include a seat occupancy detection device communicatively connected to the control device. The seat occupancy detection device may be configured to determine a seating position of the user and transmit information including the determined seating position of the user to the control device. The control device may be further configured to analyze the user demand information based on the LLMs and generate the plan for the customized scenario suitable for the user demand information by using the user demand information of the customized scenario and the SOA atomic function library based on determining that the user is the registered user or that the user is sitting on a driver seat.

The display device may include a confirmation button for indicating that the user is satisfied with the plan for the customized scenario generated by a user selection. The display device may further include a rebuild button for indicating that the user is not satisfied with the plan for the customized scenario generated through the user selection and for regenerating the plan for the customized scenario.

The control device may be further configured to, based on the user not being satisfied with the generated plan for the customized scenario, regenerate the plan for the customized scenario based on feedback information of the user until the user is satisfied. The control device may be further configured to, based on the user being satisfied with the generated plan for the customized scenario, store the generated plan for the customized scenario or store the generated plan for the customized scenario and the corresponding identity information of the user or seating position information.

The control device may be further configured to execute the plan for the customized scenario stored based on a condition of the plan for the customized scenario stored being satisfied.

The LLMs may be trained and prompt-tuned using predetermined customized scenario information. The LLMs may be installed in the control device within the vehicle or in a cloud.

The speech recognition device may further include a microphone configured to capture a speech signal of the user. The speech recognition device may further include an automatic speech recognition (ASR) module configured to convert the speech signal of the user into text information. The speech recognition device may further include a natural language processing (NLP) module configured to process and analyze the text information to understand a structure and meaning of a sentence. The speech recognition device may further include a natural language understanding (NLU) module configured to understand the text information and make a corresponding decision.

The face recognition device may include a camera configured to acquire a facial image of the user. The face recognition device may further include a processor configured to convert the acquired facial image into the facial information, extract a feature of the facial information, and compare the extracted feature with a facial feature stored in a database to determine whether the user is the registered user.

According to an embodiment of the present disclosure, a method for building a customized scenario for a vehicle using SOA-based LLMs is provided. The method may include obtaining, by a speech recognition device, user speech information. The method may further include converting, by the speech recognition device, the acquired user speech information into user demand information in a text form. The method may further include classifying, by the speech recognition device, a type of the converted user demand information. The method may further include determining, by the speech recognition device, whether the type of the user demand information is a customized scenario. The method may further include generating, by the speech recognition device, user demand information of the customized scenario based on determining that the type of the user demand information is the customized scenario. The method may further include providing, by the speech recognition device, status information of a sensor and an actuator of the vehicle via a SOA atomic function library. The method may further include analyzing, by a control device, the user demand information based on the LLMs using the user demand information of the customized scenario and the atomic function library. The method may further include generating, by the control device, a plan for the customized scenario suited to the user demand information.

The method may further include displaying to the user the plan for the customized scenario generated by a display device.

The method may further include, by a face recognition device, recognizing facial information of the user. The method may further include determining, by the face recognition device, whether the user is a registered user. The method may further include transmitting identity information of the determined user to the control device. The method may further include determining, by a seat occupancy detection device, a seating position of the user. The method may further include transmitting, by the seat occupancy detection device, seating position information of the determined user to the control device. The method may further include analyzing, by the control device, based on determining that the user is the registered user or the user is sitting on a driver seat, the user demand information based on the LLMs by using the user demand information of the customized scenario and the SOA atomic function library. The method may further include generating, by the control device, the plan for the customized scenario suited to the user demand information.

The method may further include receiving, by the control device, an indication of satisfaction from the user regarding the generated plan for the customized scenario by selecting a confirmation button on the display device. The method may further include indicating, by the control device, that the user is not satisfied with the plan for the customized scenario generated by selecting a rebuild button on the display device; and regenerating the plan for the customized scenario.

The method may further include, based on the user not being satisfied with the generated plan for the customized scenario, regenerating, by the control device, the plan for the customized scenario based on feedback information of the user until the user is satisfied. The method further includes, based on the user being satisfied with the generated plan for the customized scenario, storing, by the control device, the generated plan for the customized scenario, or storing the generated plan for the customized scenario and the corresponding identity information of the user or seating position information.

The plan for the customized scenario stored may be executed when a condition of the plan for the customized scenario stored is satisfied.

The method may further include training and prompt-tuning the LLMs using predetermined customized scenario information. The LLMs may be installed in a control device within a vehicle or in a cloud.

The method may further include capturing, by a microphone, a speech signal of the user. The method may further include converting, by an automatic speech recognition (ARS) module, the speech signal of the user into text information. The method may further include processing and analyzing, by a natural language processing (NLP) module, the text information to understand a structure and meaning of a sentence. The method may further include, understanding, by a natural language understanding (NLU) module, the text information and making a corresponding decision.

The method may further include acquiring, by a camera, a facial image of the user. The method may further include converting, by a processor, the acquired facial image into the facial information. The method may further include extracting, by the processor, a feature of the facial information. The method may further include comparing, by the processor, the extracted feature with a facial feature stored in a database to determine whether the user is the registered user.

The present disclosure provides a technical solution and provides various beneficial effects and improvements to the system which are described below.

The disclosed embodiments provide simplification of the customization process. In particular, a user may easily build individualized vehicle scenarios. The disclosed embodiments significantly lower a threshold for customization as the user does not need to deeply understand complex detailed technologies.

The disclosed embodiments provide increased user satisfaction. In particular, the disclosed embodiments provide a customized scenario that satisfies specific user demand and preferences. Therefore, the accuracy of the recognition of user's demands and requests provided to a vehicle is increased.

The disclosed embodiments provide implementation of a software defined vehicle (SDV) architecture. In particular, the disclosed embodiments provide atomic functions in an SOA that enable implementation of the SDV architecture in a vehicle. The disclosed embodiments enable improvements to provide efficiency during software upgrades and configuration changes.

A system and method for building a customized scenario for a vehicle with SOA-based LLMs according to an embodiment of the present disclosure may not only provide a more personalized driving experience to a user, but also provide technological solutions to a technical problems.

The technical problems to be solved by the present disclosure are not limited to the aforementioned problems. Other technical problems not mentioned herein should be more clearly understood from the following description by those having ordinary skill in the art to which the present disclosure pertains.

### BRIEF DESCRIPTION OF THE DRAWINGS

FIG. 1 illustrates a block diagram of a system for building a customized scenario for a vehicle using SOA-based LLMs according to an embodiment of the present disclosure.

FIG. 2 illustrates a block diagram of a system for building a customized scenario for a vehicle with SOA-based LLMs according to another embodiment of the present disclosure.

FIG. 3 illustrates a flowchart of a method for building a customized scenario for a vehicle using SOA-based LLMs according to an embodiment of the present disclosure.

FIG. 4 illustrates a flowchart of a method for building a customized scenario for a vehicle using SOA-based LLMs according to another embodiment of the present disclosure.

### DETAILED DESCRIPTION

Hereinafter, embodiments of the present disclosure are described below in detail with reference to the accompanying drawings. In the following drawings, the same reference numerals are used throughout to designate the same or equivalent elements of each drawing, even though the elements are shown in different drawings. Further, in the following description of various embodiments of the present disclosure, a detailed description of well-known configurations or functions associated with various embodiments of the present disclosure has been omitted for the purpose of clarity and brevity.

Additionally, various terms such as first, second, A, B, (a), and (b), and the like may be used solely to distinguish one element/component from the other but not to imply or suggest type, order, or sequence of the elements/components. Furthermore, all terms used herein including technical scientific terms have the same meanings as those which are generally understood by those of ordinary skill in the unless they are differently defined. Terms defined in a generally used dictionary shall be construed to have meanings matching those in the context of a related art and shall not be construed to have idealized or excessively formal meanings unless they are clearly defined in the present specification.

When a component, device, element, part, unit, module or the like of the present disclosure is described as having a purpose or performing an operation, function, or the like, the component, device, or element should be considered herein as being “configured to” meet that purpose or to perform that operation or function. Each “part”, “unit”, “module”, “component”, “device”, “element”, and the like may separately embody or be included with a processor and a memory, such as a non-transitory computer readable media, as part of the apparatus.

The embodiments of the present disclosure are implemented based on implementations of technical solutions to solve technical problems. The embodiments disclose detailed implementation methods and specific operation processes. However, the protection scope of the present disclosure is not limited to the following embodiments.

In the present disclosure, the phrase “coupled with” is defined to mean directly connected to or indirectly connected through one or more intermediate components. Such intermediate components may include both hardware and software-based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

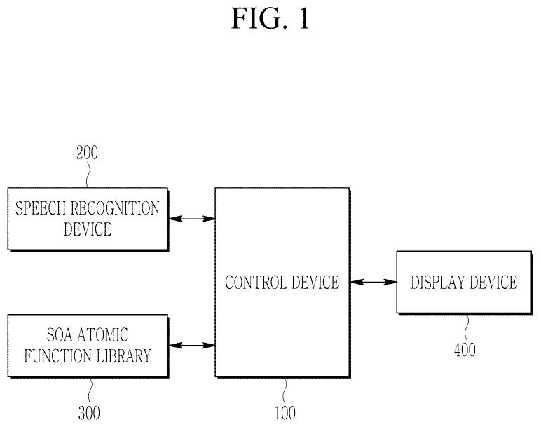

Hereinafter, embodiments of the present disclosure are described below in detail with reference to FIGS. 1-4.

FIG. 1 illustrates a block diagram of a system, e.g., a computer system, specifically configured to build a customized scenario for a vehicle using SOA-based LLMs according to an embodiment of the present disclosure.

Referring to FIG. 1, the system for building a customized scenario for a vehicle with an SOA-based LLMs according to an embodiment of the present disclosure may include a control device 100, a speech recognition device 200, an SOA atomic function library 300, and a display device 400. The control device 100 may be communicatively connected to, i.e., coupled with, the speech recognition device 200, the SOA atomic function library 300, and the display device 400.

The speech recognition device 200 may acquire user speech information, may convert the acquired user speech information into user demand information in a text form, and may classify the converted user demand information into multiple types. Additionally, the speech recognition device 200 may be configured to determine whether a type of user demand information is a customized scenario, and if the type of user demand information is determined by the speech recognition device 200 to be the customized scenario, may generate user demand information of the customized scenario. The SOA atomic function library 300 may be configured to provide status information of sensors and actuators of the vehicle. The control device 100 may be configured to analyze user demand information from the speech recognition device 200 based on large language models (LLMs) using user demand information of a customized scenario and the SOA atomic function library 300. The control device 100 may generate a plan for a customized scenario that is suitable for a user demand. The display device 400 may be configured to display the generated plan for the customized scenario to a user.

According to an embodiment of the present disclosure, a communicable connection may include a connection via wired communication and/or wireless communication. The wired communication may include controller area network (CAN), universal serial bus (USB), high definition multimedia interface (HDMI), digital visual interface (DVI), etc. CAN includes powertrain CAN bus (P_CAN), body control unit CAN bus (B_CAN), chassis control CAN bus (C_CAN), etc., but CAN communication is not limited to the CAN bus communication described above.

According to an embodiment of the present disclosure, the control device 100 may include a processor or a microprocessor (MCU). The control device 100 may additionally include a memory coupled with the processor. The action/function of the control device 100 may be implemented as a computer-readable code/algorithm/software stored in a memory, and the memory may include a non-volatile computer-readable recording medium. The non-volatile computer-readable recording medium may be any data storage device that may be read by a processor or microprocessor. Examples of computer-readable recording media include a hard disk drive (HDD), solid-state drive (SSD), a silicon disk drive (SDD), a read-only memory (ROM), a random access memory (RAM), a CD-ROM, a magnetic tape, a floppy disk, and an optical data storage device. The processor or microprocessor may execute the action/function of the control device by executing computer-readable codes/algorithms/software stored in a non-volatile computer-readable recording medium. In other words, the memory may store computer-executable instructions. The processor may be configured to execute the computer-executable instructions stored in the memory.

The large language models (LLMs) may include powerful artificial intelligence models specifically designed to understand and generate a human language. The LLMs may be based on a deep learning architecture and may capture a long-range dependency in text through a self-attention mechanism. Training of the LLMs may involve a large amount of text data, learning a general rule of a language through pre-training, and then adapting to a specific application scenario through fine-tuning for a specific task. Using the LLMs to translate text may allow for fast and accurate transfer of information between languages.

The LLMs may be provided to the control device 100 inside a vehicle, enabling direct local processing of a language input of a user to implement functionalities such as speech control and a smart assistant. In an embodiment, the LLMs may be provided in a distributed system via a cloud, with the vehicle serving as a single-entry point that sends users' inquiries to the cloud for processing and receives a resulting feedback. In other words, the disclosed embodiments utilize a specific configuration and architecture in which the LLMs are provided to the vehicle via the cloud that improves the system by leveraging more powerful computing resources and richer data sources.

To apply to a specific vehicle application scenario, the LLMs may be first trained through a set of real-world cases of customized scenarios to better understand and respond to a vehicle operation and a management requirement. Additionally, through software-in-the-loop (SIL) testing, a prompt tuning process for the LLMs may be conducted. SIL testing provides a technical solution of fine-tuning LLMs by adjusting the input prompts of the model to make the input prompts more suitable for handling certain types of tasks or responding to certain types of inquiries. In summary, through the disclosed configuration, the LLMs may better adapt to a specific vehicle application scenario and may provide a more accurate and highly efficient service. Such a customized training approach may not only improve performance of the model but also provide applicability of LLMs to various complex scenarios.

The service-oriented architecture (SOA) provides a software design and software system architecture in which an application is formed of loosely coupled services. In a vehicle system, the SOA may be used to integrate and manage different functional modules/services of the vehicle, thereby improving flexibility and scalability of the vehicle system. This modular design may not only make the system easy to maintain and upgrade, but also allow for rapid adaptation to new technology and application requirements.

An atomic library (or atomic function library or SOA atomic function library) may be a core component of SOA, containing basic, self-contained, indivisible functional units, e.g., atomic services, capable of being combined into more complex services. In the vehicle system, the atomic library may provide different control units including sensor status units, actuator control state units, infotainment units, vehicle diagnostic and maintenance units, network connectivity and communication units, and personalization units.

The sensor status units may include functional units in the atomic library that may provide access to vehicle sensor data such as a velocity, a fuel level, a temperature, a tire pressure, and the like.

The actuator control state units may include functional units in the atomic library that may be responsible for controlling an actuator of the vehicle, such as braking, steering, acceleration, and the like.

The infotainment system units may include services such as music playback, video streaming, and navigation that are configured to being operated via a user interface or controlled remotely via a smartphone app.

The vehicle diagnostics and maintenance units may include functional units in the atomic library that may provide vehicle diagnostic information, helping an owner monitor a condition of his or her vehicle and alerting the owner to required maintenance and repairs.

The network connectivity and communication units may include functional units in the atomic library that may manage a vehicle's network connectivity, including a vehicle Internet communication, a Wi-Fi hotspot, Bluetooth connectivity, and more.

The personalization settings units may include functional units of the atomic library that may store personalization settings of a user, such as a seat position, a mirror angle, an air conditioning preference, and the like, and automatically adjust them based on the user's identity.

The atomic library according to an embodiment of the present disclosure is not limited to the above contents. Via combination and collaboration of these atomic services, the SOA may provide a highly customized and intelligent platform for the vehicle system. The disclosed embodiments may not only improve vehicle performance and user experience but also provide a solid foundation for future technological innovation and value-added service. When vehicle updating, a download may be performed over-the-air (OTA) and an SOA atomic function library may be automatically updated. Therefore, the disclosed embodiments provide an architecture that delivers independent services that focus on specific capabilities. The services may be deployed and scaled independently providing agility and flexibility to the vehicle.

The speech recognition device 200 may include a microphone and a processor, e.g., a speech recognition processor, including an automatic speech recognition (ASR) module, a natural language processing (NLP) module, and a natural language understanding (NLU) module. The automatic speech recognition (ASR) module, the natural language processing (NLP) module, and the natural language understanding (NLU) module may be implemented by the processor, e.g., the speech recognition processor.

Specifically, the microphone may serve as an input device used as a speech recognition device. The microphone may play a role in capturing a speech signal of a user, and the signal may be transmitted to the processor to be analyzed and processed. The ASR module may convert the speech signal of the user into text information. The conversion process to convert the speech signal of the user into text information may involve feature extraction and sound decoding using an acoustic model and may ultimately output the user demand information in a text form. The NLP module may process and analyze text information to understand the structure and meaning of a phrase, including error correction to ensure conversion accuracy and keyword extraction to help the system capture important information from a speech of the user. The NLU module may serve to understand text information and make a corresponding decision as needed. When a user inputs a specific requirement, demand, or request, such as “building a customized scenario”, the NLU module may perform vertical domain classification on the user demand (including vehicle control and configuration, a cloud service, application interaction, speech chat, navigation, a customized scenario, and the like) to determine a type of the user demand. The NLU module may determine whether the type of the user demand is a customized scenario. When it is determined that the type of user demand information is a customized scenario, the NLU module may send the user demand information to the control device 100 to generate an appropriate response or take a corresponding action. The speech recognition device 200 may provide a convenient and accurate speech interaction experience to a user by realizing accurate conversion and in-depth understanding of speech information of the user.

The display device 400 may be a flat panel display device such as a liquid crystal display (LCD), an organic light emitting diode (OLED), and a plasma display panel (PDP). According to an embodiment of the present disclosure, the display device 400 may be a part of an AVNT (Audio, Video, Navigation & Telecommunication) device. The AVNT device may implement practical functions such as AI smart speech control, remote control, real-time mobile phone interconnection, and GPS navigation.

The display device 400 may display the generated plan for the customized scenario to the user, and if the user is not satisfied by or does not approve the generated plan for the customized scenario, the user may provide feedback through a confirmation button and a reconfiguration button on the display device, a speech command, a physical button, or any other user input method. Further, user's feedback information may be collected and transmitted to the control device 100.

According to an embodiment of the present disclosure, the display device 400 may further include a confirmation button and a rebuild button. The user may indicate satisfaction with the generated plan for the customized scenario by selecting the confirmation button. The user may indicate dissatisfaction with the generated plan for the customized scenario by selecting the rebuild button and may instruct the control device 100 to regenerate a plan for the customized scenario.

After receiving user feedback, the control device 100 may modify the customized scenario based on the provided feedback information to better satisfy the user demand. The control device 100 may regenerate a plan for a customized scenario that better suits the user demand and may display it to the user through the display device 400. According to an embodiment of the present disclosure, a user may be allowed to provide feedback multiple times until the user approves the generated plan for the customized scenario. Once the user approves the plan for the customized scenario, the plan for the customized scenario may be saved in, for example, a non-transitory memory.

A system for building a customized scenario for a vehicle using SOA-based LLMs according to an embodiment of the present disclosure may build a plan for a customized scenario based on an action and a preference of a user at a vehicle level or a cloud level by using LLMs combined with SOA, thereby enhancing smart characteristics of the vehicle and improving a driving experience of the user. In addition, a plan for a customized scenario created for the user may be displayed on an in-vehicle display screen or other user interface to determine whether the user is satisfied, i.e., to determine whether the user approves the plan for the customized scenario. If conditions of a customized scenario plan are satisfied, the customized scenario plan may be automatically executed. For example, the system may automatically adjust seat and mirror positions, and the like, depending on the customized scenario of the user. Such smart, personalized services may not only improve driving safety and comfort but also enhance an interaction between a user and a vehicle.

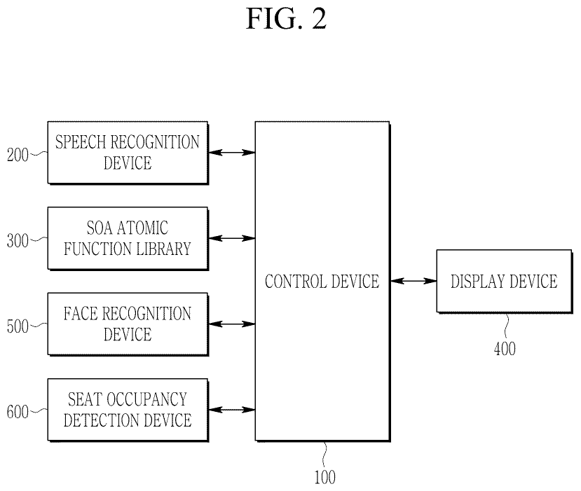

According to another embodiment of the present disclosure, a system for building a customized scenario for a vehicle with SOA-based LLMs may further include a face recognition device and a seat occupancy detection device. FIG. 2 illustrates a system for building a customized scenario for a vehicle using SOA-based LLMs according to another embodiment of the present disclosure. The system may include a control device 100, a speech recognition device 200, a SOA atomic function library 300, a display device 400, a face recognition device 500, and a seat occupancy detection device 600. A connection relationship between the control device 100, the speech recognition device 200, the SOA atomic function library 300, and the display device 400 and actions of the speech recognition device 200, the SOA atomic function library 300, and the display device 400 are similar to those of the embodiment illustrated in FIG. 1 and accordingly are not described further herein.

The control device 100 may be communicatively connected to the face recognition device 500 and the seat occupancy detection device 600. The face recognition device 500 may be configured to recognize facial information of a user, determine whether the user has been registered, and send determined user identity information to the control device 100. The face recognition device 500 may include an image capture device and a processor, e.g., a face recognition processor.

The image capture device may generally refer to a camera or other imaging apparatus capable of acquiring a facial image of a user, including both static and dynamic images. The processor may convert the facial image into facial information (i.e., data information), extract features of the facial information, and compare the extracted features with facial features stored in a database in a non-transitory memory to verify whether the two faces belong to a same person. In other words, the image capture device may check whether the user is a registered user. Once the facial features are matched with the facial data of a user registered in the database, the face recognition device may verify identity of the user. If a user performs face recognition for the first time, the face recognition device may perform face registration to obtain and store a face template of the user, and this template may be used as a reference for future facial recognition comparison.

If it is determined that the user is not a registered user, a seating position of the user may be determined by the seat occupancy detection device, and the determined user seating position information may be transmitted to the control device 100. The seat occupancy detection device may include a sensor and a processor, e.g., a seat occupancy detection processor. The seat occupancy detection device may typically include one or more sensors, such as a pressure sensor, a weight sensor, an infrared sensor, or a capacitive sensor. These sensors may detect whether a person is in the seat and an exact position of the person. Data collected by the sensor may be transmitted to the processor and analyzed to determine a seating position of a user.

The control device may additionally be configured to analyze user demand information based on the LLMs and generate a plan for a customized scenario suited to a user demand, using the user demand information and the SOA atomic function library, if it is determined by the control device that the user is a registered user or the user is seated in a driver seat.

Once the user is verified, the control device 100 may access user demand information related to that user and execute a plan for a customized scenario. Additionally, the control device 100 may also adjust and optimize a scenario setting through actual responses and feedback of the user. Such dynamic feedback and adjustment mechanisms may provide smarter, more flexible services to a user, making the user more comfortable and satisfied. The final generated customized scenario and corresponding user identity information or seating position information may be stored in a database or other form of storage system or non-transitory memory, so the user may quickly retrieve the generated customized scenario and corresponding user identity information or seating position information the next time the user uses the vehicle, thereby improving efficiency and user experience.

The system for building a customized scenario for a vehicle using SOA-based LLMs according to an embodiment of the present disclosure may verify the user demand and user identity information (verify whether the user is a driver, a registered user, and the like), may build a plan for a customized scenario according to the user demand at a vehicle level or the cloud level using LLMs combined with SOA, and may display a result thereof to the user. The user may check the plan for the customized scenario and submit a modification request, causing the customized scenario to be rebuilt and displayed repeatedly until the user is satisfied.

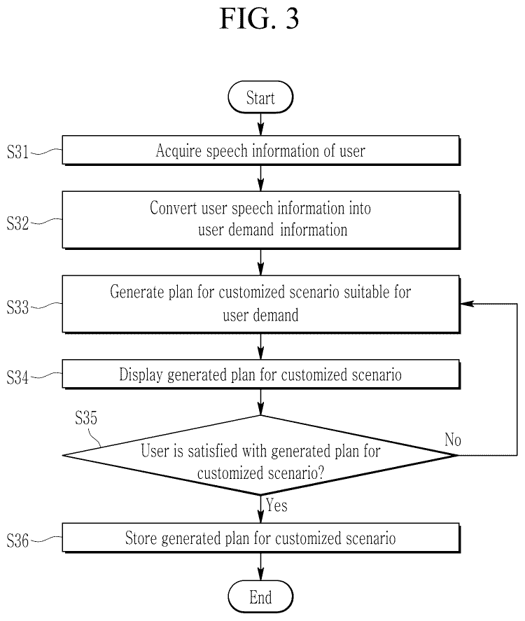

FIG. 3 illustrates a flowchart of a method for building a customized scenario for a vehicle using SOA-based LLMs according to an embodiment of the present disclosure.

In Operation S31, when the user activates an in-vehicle speech recognition function and speaks a requirement, the speech recognition device 200 may acquire speech information of the user.

In Operation S32, the speech recognition device 200 may convert the user speech information into user demand information in a text form. The speech recognition device 200 may perform vertical domain classification on the user demand information. The speech recognition device 200 may send user demand information for “building a customized scenario” for each type to the control device 100.

In Operation S33, the control device 100 may analyze the user demand information based on LLMs using the user demand information and the SOA atomic function library, and may generate a plan for a customized scenario suitable for the user demand.

In Operation S34, the display device 400 may display the generated plan for the customized scenario to the user.

In Operation S35, the user may check whether he or she is satisfied with the generated plan for the customized scenario.

If the user is not satisfied with and does not approve the generated plan for the customized scenario (“NO” in Operation S35), the user may request a rebuild of the plan for the customized scenario to the control device and also add, delete, or modify the request. The control device 100 may modify or rebuild the plan for the customized scenario according to new input from the user. The control device 100 may display a new result based on the new input to the user through the display device 400.

If the user is satisfied with the generated plan for the customized scenario (“YES” in Operation S35), the generated plan for the customized scenario may be stored in Operation S36.

Hereinafter, a method for building a customized scenario for a vehicle using SOA-based LLMs according to an embodiment of the present disclosure is described below.

In an embodiment, a user A may be a novice driver with little driving experience. The user A may not know how to prevent windshield fogging during rainy conditions while driving. In this case, when the user A activates an in-vehicle speech recognition function and requests, ‘Help me set up the vehicle such that the windows don't fog up when it rains,’ the system and method for building a customized vehicle scenario based on SOA-based LLMs according to an embodiment of the present disclosure may be driven according to a customized scenario.

The speech recognition device may convert speech information of the user A into user demand information in a text form, to proceed with vertical domain classification. In other words, the speech recognition device 200 may determine whether a user demand type is a requirement to build a customized scenario. The speech recognition device 200 may transmit user demand information in the text form converted from the user demand for “building a customized scenario” to the control device 100.

The control device 100 may analyze the user demand with SOA-based LLMs, perform logical reasoning, and generate a plan by combining SOA atomic functions of the vehicle. For example, the control device 100 may determine whether it is raining through an open rain sensor signal, and control an air conditioner mode (e.g., a wind direction of the air conditioner) and a running mode of the air conditioner (AC) through an open air conditioner control interface. A windshield heating system may be controlled via a windshield heating system interface. Accordingly, for example, the system may generate a customized scenario plan as follows: if the rainfall sensor detects rain, then set the A/C mode to ventilation (airflow directed toward the windshield), turn on the A/C, and activate the windshield heating system. Thereafter, the generated plan may be displayed to the user through the display device 400.

The system may verify whether the user A is satisfied with the generated plan. If the user A is not satisfied with the generated plan, the user A may request the control device 100 to rebuild the generated plan for the customized scenario until he/she is satisfied. After the user A is satisfied with the generated plan for the customized scenario, the generated plan for the customized scenario may be stored.

Thereafter, when the user A uses the vehicle, if a condition of the plan for the customized scenario stored is satisfied (i.e., it rains), the vehicle may automatically execute the customized scenario to prevent a window from fogging up (without needing to verify identity of the user). In other words, the customized scenario may include setting the air conditioner mode=blower mode (the air conditioner's wind direction is toward the window), turning on the AC, and turning on the windshield heating system, thereby optimizing the vehicle's usage efficiency and seating experience.

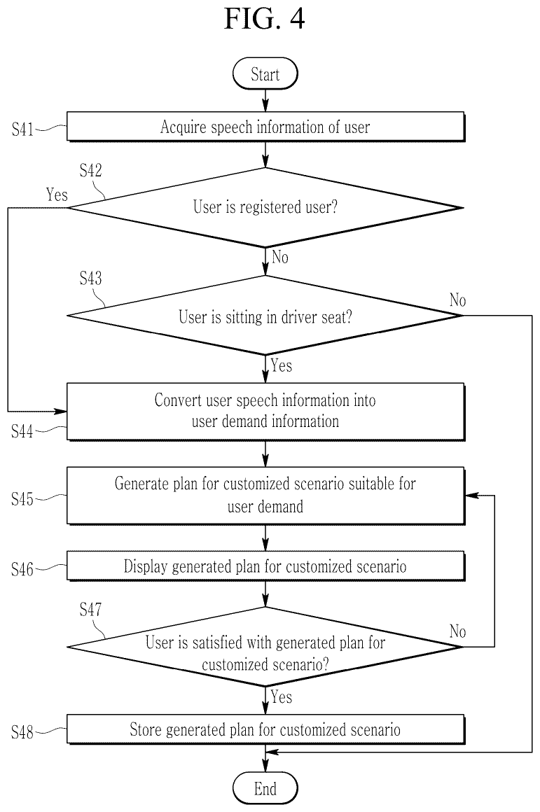

FIG. 4 illustrates a flowchart of a method for building a customized scenario for a vehicle using SOA-based LLMs according to another embodiment of the present disclosure.

In Operation S41, the user may activate an in-vehicle speech recognition function and speak a demand, i.e., a requirement or request. The speech recognition device 200 may obtain speech information of the user.

In Operation S42, the face recognition device 500 may be configured to recognize facial information of a user, determine whether the user has been registered, e.g., whether the user is a registered user, and send determined user identity information to the control device 100.

If the face recognition device 500 determines that the user is not a registered user (i.e., “No” in Operation S42), a seating position of the user may be determined by the seat occupancy detection device 600 in Operation S43, and the determined user seating position information may be transmitted to the control device 100.

If the face recognition device 500 determines that the user is a registered user (“Yes” in Operation S42) or that the user is sitting in the driver seat (“Yes” in step S43), then in Operation S44, the speech recognition device 200 may convert the speech information of the user into user demand information in a text form, and may perform vertical domain classification on the user demand information. The speech recognition device may send user demand information for “building a customized scenario” for each demand type to the control device 100.

In Operation S45, the control device 100 may analyze the user demand information based on LLMs using the user demand information and the SOA atomic function library. The control device 100 may generate a plan for a customized scenario suitable for the user demand.

In Operation S46, the display device 400 may display the generated plan for the customized scenario to the user.

In Operation S47, the user may check whether the user is satisfied with the generated plan for the customized scenario.

If the user is not satisfied with the generated plan for the customized scenario (“NO” in Operation S47), the user may request a rebuild of the control device 100 and also may add, delete, or modify the request. The control device 100 may modify or rebuild the plan of the customized scenario according to a new input. The control device 100 may display a new result of the new plan of the customized scenario to the user through the display device 400.

If the user is satisfied with the generated plan for the customized scenario (“YES” in Operation S47), the generated plan for the customized scenario may be stored in Operation S48.

An action process of a method for building a customized scenario for a vehicle using SOA-based LLMs according to another embodiment of the present disclosure is described below.

In an embodiment, a user A is a novice driver with little driving experience. The user A may not know how to prevent windshield fogging during rainy conditions while driving. In this case, when the user A activates an in-vehicle speech recognition function and requests, ‘Help me set up the vehicle such that the windows don't fog up when it rains,’ the system and method for building a customized vehicle scenario based on SOA-based LLMs according to another embodiment of the present disclosure may be driven according to a customized scenario.

The face recognition device 500 may be configured to recognize facial information of the user A, determine whether the user A has been registered, and send determined user identity information to the control device 100.

If the face recognition device 500 determines that the user A is not a registered user, a seating position of the user A may be determined by the seat occupancy detection device 600, and the determined user seating position information may be transmitted to the control device 100.

When the face recognition device 500 determines that the user A is a registered user or that the user A is sitting in the driver seat, the speech recognition device 200 may convert speech information of the user A into user demand information in a text form, and may perform vertical domain classification. In other words, the speech recognition device 200 may determine whether a user demand type is a requirement to build a customized scenario. The speech recognition device 200 may transmit user demand information in the text form converted from the user demand for “building a customized scenario” to the control device 100.

The control device 100 may analyze the user demand with SOA-based LLMs, perform logical reasoning, and generate a plan by combining SOA atomic functions of the vehicle. For example, it may determine whether it is raining through an open rain sensor signal, and control an air conditioner mode (e.g., a wind direction of the air conditioner) and a running mode of the AC through an open air conditioner control interface. A windshield heating system may be controlled via a windshield heating system interface. Accordingly, for example, the system may generate a customized scenario plan including: if the rainfall sensor detects rain, then set the A/C mode to ventilation (airflow directed toward the windshield), turn on the A/C, and activate the windshield heating system. Thereafter, the generated plan may be displayed to the user A through the display device 400 to determine whether the user A is satisfied with the generated plan.

If the user A is not satisfied with the generated plan, the user A may request the control device 100 to rebuild the generated plan for the customized scenario until he/she is satisfied. If the user A is satisfied with the generated plan for the customized scenario, the generated plan for the customized scenario may be stored.

Thereafter, when it rains while the user is using the vehicle, the vehicle may first verify the identity of the user, and only if it is determined that the user is a registered user or that the user is sitting in the driver seat, the vehicle may automatically execute the plan for the customized scenario to prevent the window from fogging up by setting the air conditioning mode=ventilation mode (the air conditioner's wind direction is toward the window), turning on the AC, and turning on the windshield heating system, thereby optimizing the vehicle's usage efficiency and seating experience.

A system and a method for building a customized scenario for a vehicle using SOA-based LLMs according to an embodiment of the present disclosure may build a plan for a customized scenario based on an action and a preference of a user at a vehicle level or a cloud level by using LLMs combined with SOA, thereby significantly reducing difficulty in building a customized scenario and enabling more users to build their own scenarios, enhancing smart characteristics of the vehicle and improving a driving experience of the user.

Various embodiments of the present disclosure may not enumerate all possible combinations but rather illustrate representative aspects of the present disclosure. Furthermore, the contents described in the embodiments may be applied independently or in combination.

While this disclosure has been described in connection with what is presently considered to be practical embodiments, it is to be understood that the disclosure is not limited to the disclosed embodiments. On the contrary, the disclosure is intended to cover various modifications and equivalent arrangements included within the spirit and scope of the appended claims.

What is claimed is:

1. A system specifically configured to build a customized scenario for a vehicle using large language models (LLMs) based on a service-oriented architecture (SOA), the system comprising:
a speech recognition device configured to acquire user speech information, convert the acquired user speech information into user demand information in a text form, classify the converted user demand information, determine whether a type of the user demand information is a customized scenario, and, based on determining that the type of the user demand information is the customized scenario, generate user demand information of the customized scenario;
an SOA atomic function library stored in a non-transitory memory, the SOA atomic function library configured to provide status information of a sensor and an actuator of the vehicle; and
a control device configured to be communicatively connected to the speech recognition device and the SOA atomic function library, and to analyze the user demand information based on the LLMs and generate a plan for the customized scenario suitable for the user demand information by using user demand information of the customized scenario and the SOA atomic function library.

2. The system of claim 1, further comprising:
a display device communicatively connected to the control device and configured to display the plan for the generated customized scenario to a user.

3. The system of claim 2, further comprising:
a face recognition device configured to be communicatively connected to the control device, recognize facial information of a user, determine whether the user is a registered user, and transmit identity information of the determined user to the control device; and
a seat occupancy detection device communicatively connected to the control device, and configured to determine a seating position of the user and transmit information including the determined seating position of the user to the control device,
wherein the control device is further configured to analyze the user demand information based on the LLMs and generate the plan for the customized scenario suitable for the user demand information by using the user demand information of the customized scenario and the SOA atomic function library, based on determining that the user is the registered user or the user is sitting on a driver seat.

4. The system of claim 2, wherein the display device further includes:
a confirmation button for indicating that the user is satisfied with the plan for the customized scenario generated by a user selection; and
a rebuild button for indicating that the user is not satisfied with the plan for the customized scenario generated through the user selection and for regenerating the plan for the customized scenario.

5. The system of claim 4, wherein the control device is further configured to:
based on the user not being satisfied with the generated plan for the customized scenario, regenerate the plan for the customized scenario based on feedback information of the user until the user is satisfied; and
based on the user being satisfied with the generated plan for the customized scenario, store the generated plan for the customized scenario or store the generated plan for the customized scenario and the corresponding identity information of the user or seating position information.

6. The system of claim 5, wherein the control device is further configured to execute the plan for the customized scenario stored based on a condition of the plan for the customized scenario stored being satisfied.

7. The system of claim 1,
wherein the LLMs are trained and prompt-tuned using predetermined customized scenario information, and
wherein the LLMs are installed in the control device within the vehicle or in a cloud.

8. The system of claim 1, wherein the speech recognition device further includes:
a microphone configured to capture a speech signal of the user;
an automatic speech recognition (ASR) module configured to convert the speech signal of the user into text information;
a natural language processing (NLP) module configured to process and analyze the text information to understand a structure and meaning of a sentence; and
a natural language understanding (NLU) module configured to understand the text information and make a corresponding decision.

9. The system of claim 3, wherein the face recognition device includes:
a camera configured to acquire a facial image of the user; and
a processor configured to convert the acquired facial image into the facial information, extract a feature of the facial information, and compare the extracted feature with a facial feature stored in a database to determine whether the user is the registered user.

10. A method for building a customized scenario for a vehicle using SOA-based LLMs, the method comprising:
obtaining, by a speech recognition device, user speech information;
converting, by the speech recognition device, the acquired user speech information into user demand information in a text form;
classifying, by the speech recognition device, a type of the converted user demand information;
determining, by the speech recognition device, whether the type of the user demand information is a customized scenario;
generating, by the speech recognition device, user demand information of the customized scenario based on determining that the type of the user demand information is the customized scenario; and
providing, by the speech recognition device, status information of a sensor and an actuator of the vehicle via an SOA atomic function library;
analyzing, by a control device, the user demand information based on the LLMs using the user demand information of the customized scenario and the atomic function library; and
generating, by the control device, a plan for the customized scenario suited to the user demand information.

11. The method of claim 10, further comprising:
displaying to the user the plan for the customized scenario generated by a display device.

12. The method of claim 11, further comprising:
recognizing, by a face recognition device, facial information of the user;
determining, by the face recognition device, whether the user is a registered user;
transmitting, by the face recognition device, identity information of the determined user to the control device;
determining, by a seat occupancy detection device, a seating position of the user;
transmitting, by the seat occupancy detection device, seating position information of the determined user to the control device;
analyzing, by the control device, based on determining that the user is the registered user or that the user is sitting on a driver seat, the user demand information based on the LLMs by using the user demand information of the customized scenario and the SOA atomic function library; and
generating, by the control device, the plan for the customized scenario suited to the user demand information.

13. The method of claim 11, further comprising:
receiving, by the control device, an indication of satisfaction from the user regarding the generated plan for the customized scenario by selecting a confirmation button on the display device;
indicating, by the control device, that the user is not satisfied with the plan for the customized scenario generated by selecting a rebuild button on the display device; and
regenerating, by the control device, the plan for the customized scenario.

14. The method of claim 13, further comprising:
based on the user not being satisfied with the generated plan for the customized scenario, regenerating, by the control device, the plan for the customized scenario based on feedback information of the user until the user is satisfied; and
based on the user being satisfied with the generated plan for the customized scenario, storing, by the control device, the generated plan for the customized scenario, or storing the generated plan for the customized scenario and the corresponding identity information of the user or seating position information.

15. The method of claim 14, wherein
the plan for the customized scenario stored is executed when a condition of the plan for the stored customized scenario is satisfied.

16. The method of claim 11, further comprising:
training and prompt-tuning the LLMs using predetermined customized scenario information, wherein the LLMs are installed in the control device within the vehicle or in a cloud.

17. The method of claim 10, further comprising:
capturing, by a microphone, a speech signal of the user;
converting, by an automatic speech recognition (ARS) module, the speech signal of the user into text information;
processing and analyzing, by a natural language processing (NLP) module, the text information to understand a structure and meaning of a sentence; and
understanding, by a natural language understanding (NLU) module, the text information and making a corresponding decision.

18. The method of claim 12, further comprising:
acquiring, by a camera, a facial image of the user; and
converting, by a processor, the acquired facial image into the facial information;
extracting, by the processor, a feature of the facial information; and
comparing, by the processor, the extracted feature with a facial feature stored in a database to determine whether the user is the registered user.
